(19) United States
(12) Patent Application Publication
(10) Pub. No.: US 2006/0176508 A1
(43) Pub. Date: Aug. 10, 2006

(54) Communication apparatus

(75) Inventor: Yasuo Sugahara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/238,955

(22) Filed: Sep. 30, 2005

(30) Foreign Application Priority Data
Feb. 4, 2005 (JP) 2005-028360

(51) Int. Cl. G06F 3/12

(52) U.S. Cl. 358/1.15

(57) ABSTRACT

A communication apparatus comprises a reception section that receives format-specifying data specifying an attribute relating to a format of a document and data which identifies contents to which the format is applied, from a communication terminal; a generation section that generates document data by applying the format-specifying data to the identified contents; and a transmission section that transmits the document data generated by the generation section.

### BACKGROUND OF THE INVENTION

The present invention relates to a communication apparatus with which a receiver side can specify a document format.

In recent years, online commercial transaction, online shopping, various online procedures, and the like using the Internet have been widespread. Accordingly, documents (hereinafter referred to as “electronic documents”) such as an estimate and a confirmation of order can also be obtained online.

FIG. 13 is a flowchart showing an example of issuing an “estimate” on a conventional shopping site. (1) A user selects a product to be purchased from a plurality of products displayed on a screen used for selecting products. (2) The user requests the shopping site to prepare an estimate for the selected product. Then, (3) upon reception of the estimate preparation request, the shopping site prepares an estimate for the selected product to be purchased and presents the estimate to the user.

In general, when asking the shopping site to prepare an estimate, a purchaser clicks a “prepare estimate” button or the like displayed on the screen of the user's terminal. Then, the shopping site automatically prepares an estimate based on information (selected product to be purchased, user information, and the like) which have been selected or inputted by the time the purchaser requests the shopping site to prepare an estimate. Thereafter, the prepared estimate is transmitted to the user and the estimate is displayed on the screen of the user's terminal. The purchaser obtains a copy of the estimate by printing the screen, if necessary. As described above, the estimate has been prepared using a format prepared in advance by the shopping site.

On the other hand, the following technique is known as a technique of preparing an electronic document on a client device, which does not obtain an electronic document from a web site such as a shopping site. The technique includes (1) writing necessary data at a corresponding cell address of a document having a unique format prepared for each client device and (2) changing definition information in the electronic document and preparing again the electronic document.

Patent document 1 relates to “a method of exchanging data” between a server device and client devices. Further, Patent document 1 discloses that the server simply outputs “an intermediate data file”.

Patent document 2 discloses a method of preparing an electronic document in a workflow system for controlling circulation of electronic documents.

[Patent document 1] JP 2002-108665 A

[Patent document 2] JP 2003-256626 A

Methods for obtaining a document issued by a document provider (a salesperson, in shopping) includes a method of printing a displayed screen as it is and a method of downloading data for printing. However, the format (items to be displayed, a display order, a page structure, and the like) of the document is predetermined by the document provider.

Therefore, when a document receiver (a purchaser, in shopping) desires to specify the format of the document according to a company's policy or the like, a document which can be obtained online is insufficient, so there arises a need of requesting the document provider to mail a document separately prepared by handwork. Therefore, a document in a format other than the predetermined format provided by the document provider is to be issued. This is troublesome for both the provider and the receiver.

### SUMMARY OF THE INVENTION

The present invention has been made to solve such a problem. It is an object of the present invention to provide a communication apparatus in which a provider issues a document in a format desired by a receiver, by making it possible for the receiver to specify the format of the document.

To achieve the above-described object, the present invention provides a communication apparatus, including: a reception section that receives format-specifying data specifying an attribute relating to a format of a document and data which identifies contents to which the format is applied, from a communication terminal; a generation section that generates document data by applying the format-specifying data to the identified contents; and a transmission section that transmits the document data generated by the generation section.

According to the communication apparatus, the format-specifying data specifying an attribute relating to a format of a document and data which identifies contents to which the format is applied are received from the communication terminal, and document data is generated by applying the format-specifying data to the identified contents, so that the communication apparatus can generate the document data to which the format-specifying data received from the communication terminal is applied.

Further, the present invention provides a communication terminal, including: a display section that displays each of a plurality of items in a document in a selection-allowed manner; a selection section that selects the item displayed on the display section; a specifying section that specifies an attribute with respect to the selected item; a display control section that changes a display attribute of the selected item in accordance with the specified attribute; and a format-specifying-data generation section that generates format-specifying data which includes data indicating attributes with respect to the plurality of items displayed on the display section.

According to the communication terminal, the display attribute of the selected item is changed according to the attribute specified by the specifying section, and the format-specifying data which includes data indicating attributes with respect to the plurality of items displayed on the display section is generated, so that the format-specifying data can be visually specified.

### DESCRIPTION OF THE DRAWINGS

FIG. 1 is a flowchart illustrating an outline of a process between a document provider side device and a document receiver side terminal, according to the present invention.

FIG. 2 is a flowchart of a process performed when a format file is uploaded from a user terminal to a server.

FIG. 3 is a diagram showing a specific example of items described in an estimate.

FIG. 4 is a diagram showing a specific example of a format file in which attributes (a) to (c) are set for each of items [A] to [I].

FIG. 5 is a diagram showing an estimate prepared according to the format file shown in FIG. 4.

FIG. 6 is a diagram showing another specific example of a format file.

FIG. 7 is a diagram showing an estimate prepared according to the format file shown in FIG. 6.

FIG. 8 is a diagram showing a display example of a screen for editing a display format by using a user interface (UI).

FIG. 9 is a diagram showing a display example of a screen for editing a display format by using the user interface (UI).

FIG. 10 is a flowchart showing a process in which an online shopping site issues an estimate in a format specified by the user.

FIG. 11 is a flowchart illustrative of a process of preparing an estimate (document) by the server using a received format file (format data).

FIG. 12 is a diagram showing an example of associating user registration information registered in the server with format data.

FIG. 13 is a flowchart showing an example of issuing an “estimate” on a conventional shopping site.

### DETAILED DESCRIPTION OF THE INVENTION

Hereinafter, a communication apparatus according to an embodiment of the present invention will be described with reference to the accompanying drawings. A configuration of the embodiment is given for illustrative purpose, so the present invention is not limited to the configuration of the embodiment. Note that the present invention can be implemented by use of hardware and software. To implement the present invention by use of software constituted by a program, the program constituting the software is installed in hardware such as a computer so that various functions can be realized. The program is installed in the computer or the like through a communication line or by using a computer-readable storage medium.

Here, the computer-readable storage medium is a storage medium capable of accumulating information such as data or a program electrically, magnetically, optically, mechanically, or by means of chemical action, and readable from a computer. Of such storage media, storage media removable from the computer include a flexible disk, a magnetic optical disk, a CD-ROM, a CD-R/W, a DVD, a DAT, an 8 mm tape, and a memory card. In addition, storage media fixed to a computer include a hard disk and a ROM (read only memory).

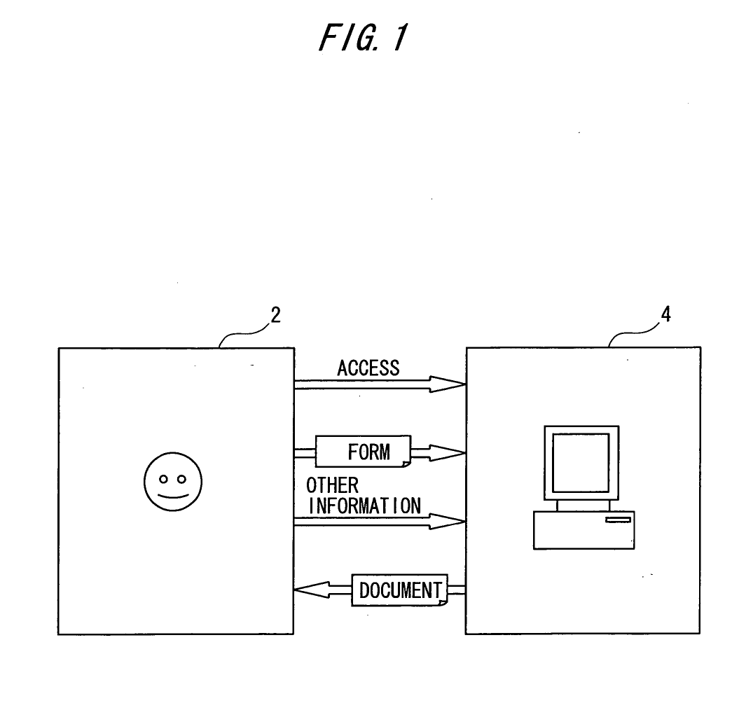

FIG. 1 is a flowchart illustrating an outline of a process between a document provider side device and a document receiver side terminal, according to the present invention. A communication system of this embodiment divides data used for preparing a document into “description contents (contents)” and a “description format (format)” and holds them. With this configuration, the communication system provides the user with a function for specifying any description format with respect to the same description contents.

The document provider side prepares the “description contents” and the document receiver side prepares the “description format”. A site providing documents completes the document by applying the “description format” to the “description contents” and presents the document to the document receiver side.

In FIG. 1, the communication system of the present invention is composed of a user terminal 2 (corresponding to a “communication terminal” of the present invention) on a user side that receives a document issuing service and a server 4 (corresponding to a “communication apparatus” of the present invention) on a side that provides the document issuing service. The user terminal 2 and the server 4 are connected to each other through a communication line such as the Internet. The communication line can be wired or wireless.

First, the user terminal 2 accesses the server 4 for product purchases, various procedures, or the like. Next, the user terminal 2 transmits to the server 4 a “description format” of a document. When the server.4 judges that the information of the “description format” transmitted from the user terminal 2 is insufficient for preparing the document, the server 4 requests the user terminal 2 to transmit lacking information. Upon reception of the request from the server 4, the user terminal 2 transmits the lacking information (other information) to the server 4. Finally, the server 4 automatically prepares the document based on the “description contents” and the “description format” transmitted from the user terminal 2 and automatically transmits the prepared document to the user terminal 2.

Here, unlike a method of preparing documents by providing only “data” in an XML (Extensible Markup Language) format or the like for the receiver side, final documents are prepared by the provider side so that “reliability”, which is a requisite for commercial transactions, can be ensured.

If the provider side provides the receiver side with only data for preparing the document, the receiver side can freely prepare a display format. Thus, it cannot be guaranteed that the document is issued by the receiver side. The present invention relates to a technique to be applied to issuance of documents which are required to secure the “reliability”.

[Preparation of Description Format]

Next, preparation methods performed when the document receiver side prepares a description format are exemplified.

(A) Uploading a format file: A method in which the document receiver side uses the XML or the like to prepare a “format file (corresponding to “format-specifying data” of the present invention)” in which the description format is described, and uploads the format file to the site of the document provider side.

(B) Editing by means of WYSWYG (what you see is what you get): A method in which a user interface for editing a document format is prepared on the site of the document provider side, and the document receiver side performs editing.

(A) is a preparing method in which a user directly inputs numeric values or the like in the format file, and (B) is a method of preparing a format file by using the user interface.

[(A) Explanation of Uploading Format File]

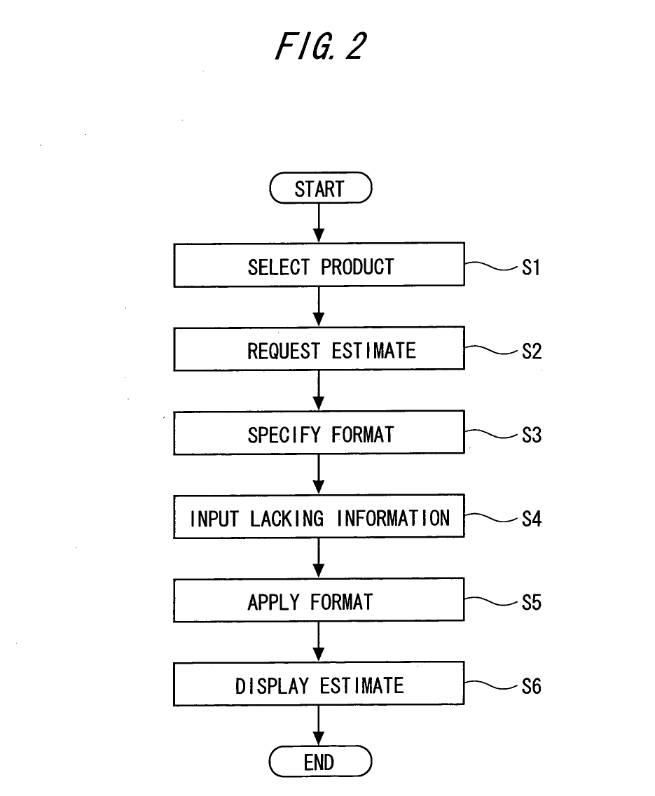

FIG. 2 is a flowchart of a process performed when a format file is uploaded from the user terminal 2 to the server 4. In this embodiment, a case in which the shopping site (the server 4) issues an “estimate” will be described hereinafter.

The user terminal 2 displays products which can be purchased and which are transmitted from the server 4, on the display so that a user can select them. When the user selects a desired product from a product selection screen, the user terminal 2 detects the selection operation (S1). With this detection, the user terminal 2 transmits product selection information identifying the selected product to the server 4 and requests the server 4 to prepare an estimate therefor (S2).

Next, the user terminal 2 transmits a format file to the server 4 (S3). When requesting the server 4 to prepare the estimate, the user terminal 2 may attach a format file prepared in advance by the user terminal 2 to transmit it to the server 4.

When the information described in the format file transmitted to the server 4 is insufficient for preparing a final estimate, the user terminal 2 urges, in response to a re-input request from the server 4, the user to input lacking information (S4). On the other hand, when the server 4 judges that there is no lacking information in the format file transmitted from the user terminal 2, the server 4 does not request the user terminal 2 to re-input information.

The server 4 applies the format file transmitted from the user terminal 2 to estimate data (data identified by product selection information and the like: a product name, a model name, quantity, a unit price, and the like) (S5). An estimate (corresponding to “document data” of the present invention) in the format specified by the user terminal 2 is prepared and transmitted to the user terminal 2. Then, the user terminal 2 receives the estimate and displays the estimate on the screen (S6).

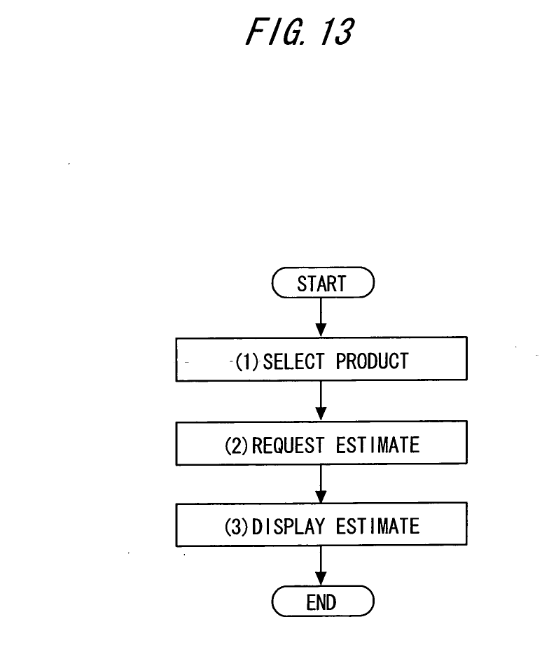

As shown in Steps S3 and S4 of FIG. 2, the present invention is different from the conventional technique shown in FIG. 13 in the following processes: (1) a process of transmitting a format file from the user terminal 2; (2) a process of judging whether there is lacking information; and (3) a process of applying the specified format to estimate data.

The “format file” transmitted from the user side in Step S3 is prepared on the user terminal 2 by the user himself/herself. In preparing the format file, the user terminal 2 downloads a “document” used for preparing the format file from the server 4. It is efficient for the user to prepare the format file based on the “document”.

When the document includes a format-file preparing method and a format-file template, the user can prepare a format file by merely altering a template file when needed. A method of adding a new item, described later, or the like may be described in the document.

In the format file, display/non-display attributes, a display order, display positions, and additional information (sentences such as comments, a new item such as a user management number) of data can be described. The user terminal 2 provides the prepared format file to the server 4 by uploading it.

Next, a method of preparing a format file by use of the user interface will be described.

“(B) The WYSWYG method” is different from “(A) the format-file uploading method”, where the user prepares the format file in advance, in that the format file is prepared by editing a display format on the screen of the user terminal 2 by using the user interface.

In Step S4, lacking information which cannot be specified in a format file (such as the address to which the estimate is to be sent and a special instruction) may be input and transmitted to the server 4. As a method of transmitting lacking information to the server 4, the lacking information may be described in a format file, or the user may display an input screen on the screen of the user terminal 2 and directly input the lacking information. Further, when the user inputs as lacking information an item which a server provider does not anticipate, the template to be provided for the user may be changed such that the item can be specified when the format file is prepared.

In Step S5, in order to apply the “description contents” such as the selected product and personal information of the user to the format of the estimate, the server 4 performs format application processing in accordance with the “description format” described in the format file. As described above, the server 4 automatically prepares the estimate by combining the format file (description format) and the contents of the estimate (description contents).

[Specific Example of the Format File]

As described above, the format file defines display attributes (hereinafter referred to as “attributes”) of a document. Each line of the document file defines the display attribute of each item in the document. This embodiment shows an example in which one item is set in one line in a document. However, this embodiment is not limited to a case in which one line has only one item.

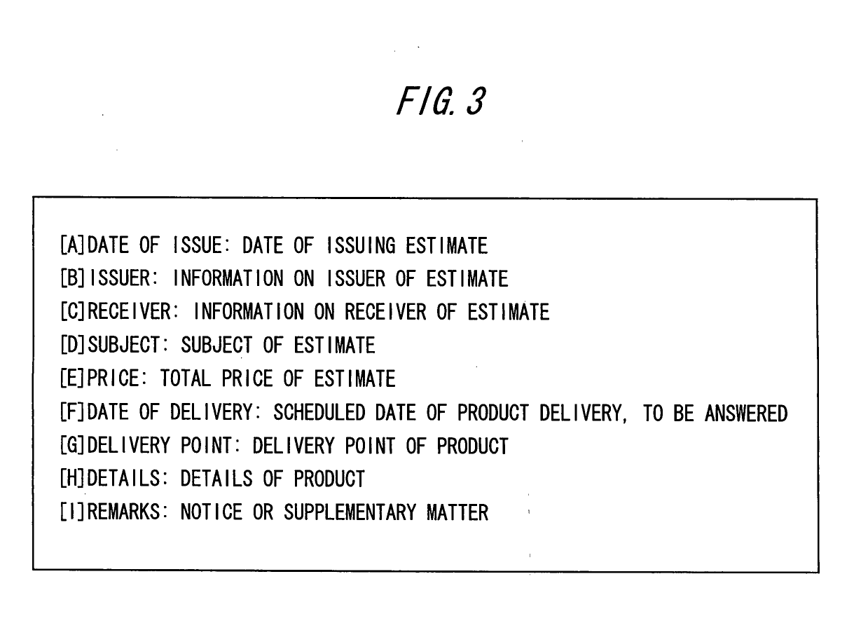

FIG. 3 is a diagram showing a specific example of items to be described in an estimate. FIG. 3 shows plural items (item basic information) for which attributes can be set in the format file prepared by the user terminal 2 in Step S3 shown in FIG. 2.

The format file includes data ((a) display order, (b) display format, and (c) character size) identifying items [A] to [I] and attributes (format) of the respective items. In this embodiment, a CSV file is used as an example of the form of the format file. Alternatively, as another form of the format file, when an XML language or the like is used, detailed settings can be performed as compared with the CSV file.

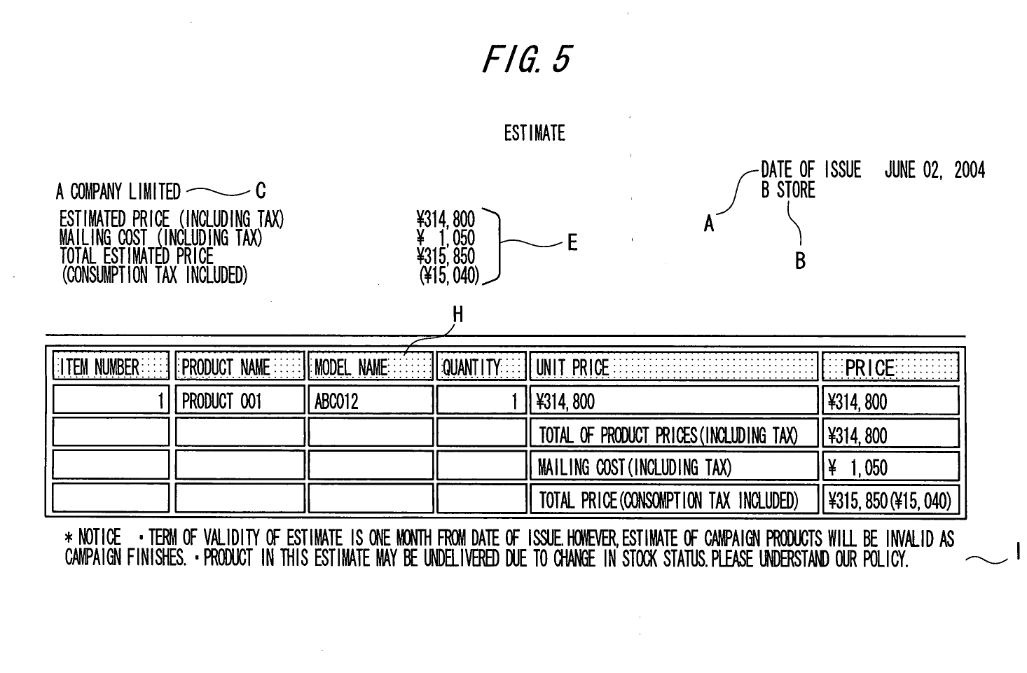

Note that an item [I] corresponds to “* notice (remarks)” shown in FIG. 5. The item is added by the document provider side, so the document receiver side cannot specify the attribute to make the item undisplayed. In this embodiment, the item is described in the format file for explanation. Only when the document receiver sets the attribute of the item [I] to non-display, the server 4 may ignore only the setting of the attribute of the item [I] and automatically prepare the estimate. In other words, the item [I] is always displayed on the estimate irrespective of the user setting.

The item basic information shown in FIG. 3 is held in advance by the server 4. For example, the server 4 holds the item basic information by the time when the server 4 transmits the product selection screen to the user terminal 2 (“S1” in FIG. 2). The user specifies as the “format” how the item basic information is to be displayed on the estimate.

Next, an attribute which can be specified for each piece of the item basic information is defined.

(a) Display order: An arrangement order on the estimate is specified with a numeric value. When “1” is specified, the item concerned is “displayed”. When “0” is specified, the item concerned is “non-displayed”.

(b) Display format: A display position in a lateral direction is specified with a numeric value. One of the following items is selected: 1: left adjust, 2: right adjust, and 3: centering.

(c) Character size: The size of characters to be displayed is specified with a numeric value indicating the font size.

Although an example of specifying the attributes (a) to (c) with numeric values is described, other specifying methods may be employed. For example, the display format may be specified with a letter, such as “L: left adjust”, “R: right adjust”, or “M: centering”.

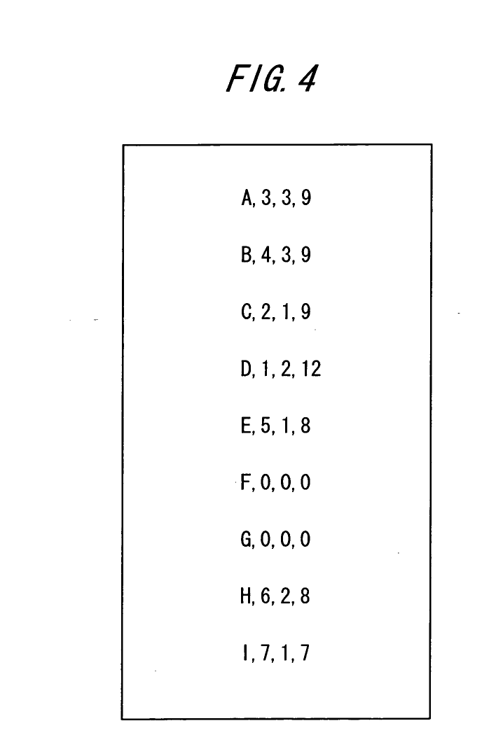

FIG. 4 is a diagram showing a specific example of a format file in which the attributes (a) to (c) are set for each of the items [A] to [I]. FIG. 4 shows an example in which the attributes are set for each item in the order of (a) to (c) in the CSV form. In each line in the format file, set values are arranged in the order of “item name, (a), (b), and (c)”.

For example, attributes (3, 3, 9) are set for an item [A: date of issue] shown in FIG. 4. According to the format designation (corresponding to “format-specifying data” of the present invention), the server 4 judges that the “date of issue” is to be centered and displayed on the third line from the top at a font size of 9 points.

FIG. 5 is a diagram showing an estimate prepared according to the format file shown in FIG. 4. As the designation described above, information is described on the estimate in the order of “subject”, “receiver”, “date of issue”, “issuer”, “price”, “details”, and “remarks”.

The “subject” is left-adjusted and displayed at a font size of 12 points. The “receiver” is left-adjusted and displayed at a font size of 9 points. “F: date of delivery” and “G: delivery point” are not displayed.

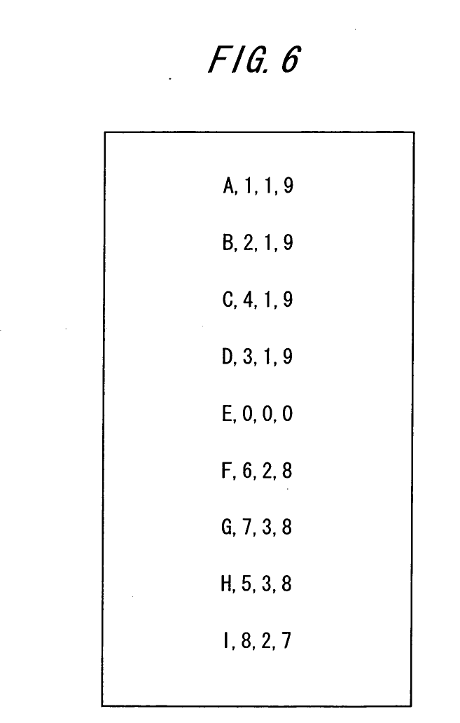

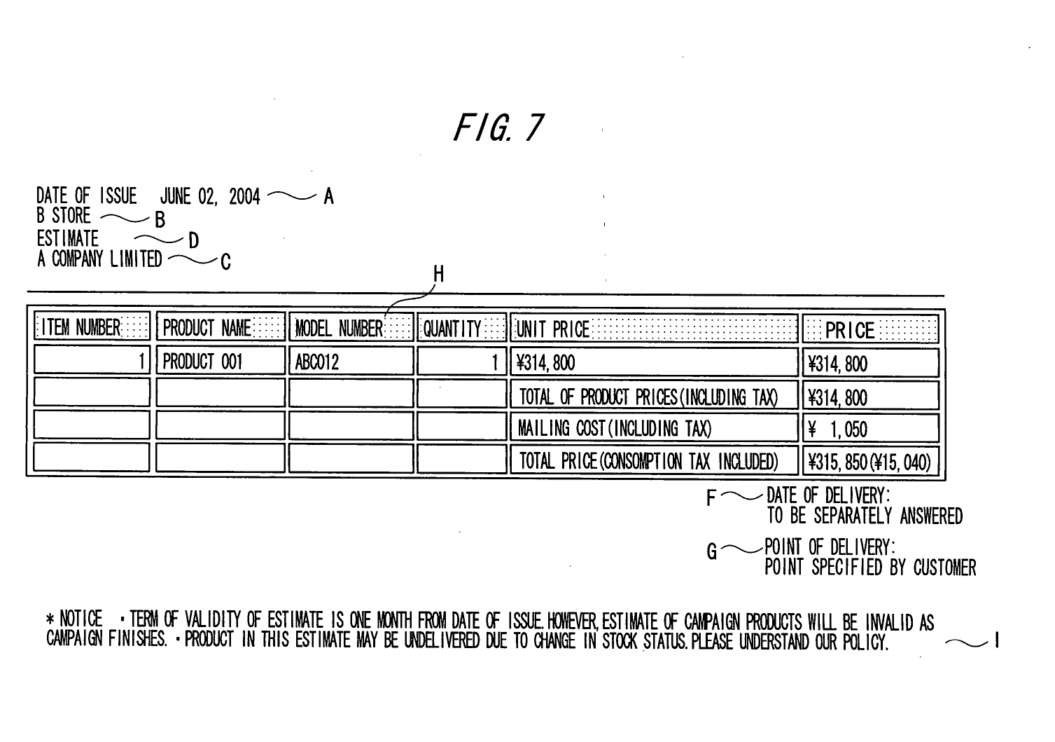

FIG. 6 is a diagram showing another specific example of a format file. FIG. 7 is a diagram showing an estimate prepared according to the format file shown in FIG. 6. In the format file shown in FIG. 6, “E: price” is specified to be non-displayed.

In the above-described example, only a “line” is specified as the “display order”. As another “display order”, plural pieces of information may be displayed in one line. The display format can be variously changed by, for example, methods of specifying the “display order” with use of a tabular composition such as TABLE tag of HTML or specifying coordinates on the estimate as the “display position”.

Further, the format can be expanded, if necessary, by making it possible to specify a decoration of characters such as “bold” in addition to the font size, or to specify a font type such as “gothic” or “Mincho” (corresponding to “font attribute” of the present invention).

Here, in a case of adding a comment or the like of the receiver side, the information to be added is input by the receiver side in Step S4 of FIG. 2 before the server 4 applies the format file, so the information can be embedded in the document.

[(B) Editing in WYSWYG]

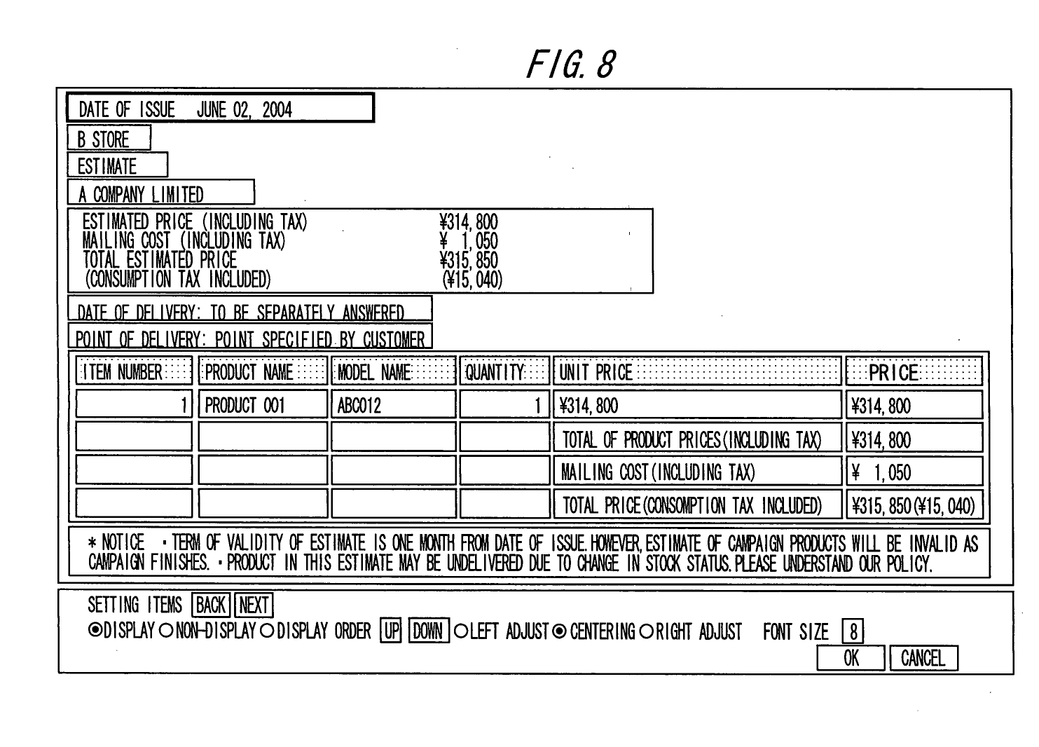

FIG. 8 is a diagram showing a display example of the screen for editing a display format by using the user interface (UI). FIG. 8 shows another method of preparing the format file made in Step S3 of FIG. 2. The user can change the order of respective setting items and set attributes by using an operation panel displayed in a lower portion, while viewing the screen displayed in an upper portion.

For example, when the item “estimate” is selected through a mouse operation, the user terminal 2 sets the selected item to a flashing state. Next, when the “centering” is selected, the user terminal 2 moves the item “estimate” to the center and displays it. Further, when the non-display state is selected, the user terminal 2 displays an item by a dashed line. This visually shows that the item is set to be non-displayed while the item for which the non-display state is set can be displayed again.

In other words, the user does not directly edit the format file to set numeric values and upload it to the server 4, but the user directly adjusts a layout on the screen. Therefore, the user can visually perform, on the user terminal 2, preparation, update, or the like of the format file to be transmitted to the server 4 .

The format file prepared in this embodiment is reusable. For example, the server 4 holds a prepared “description format (format file)”, and associates the “description format” with “user management” or “member management” and stores it. Therefore, the user can reuse from the next time onward, the “description format” held by the server 4 by making it possible to specify the once prepared “description format” on the product selection screen or the UI.

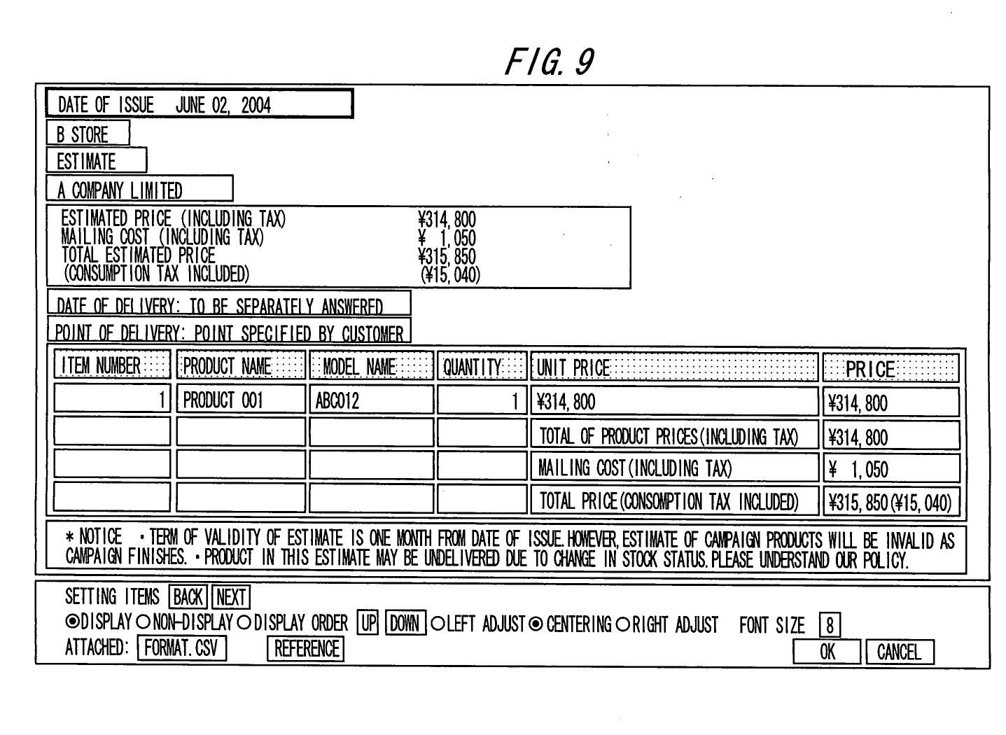

FIG. 9 shows an example of attaching the format file, as shown in FIG. 4, prepared in advance by the user. The user terminal 2 may transmit the attached format file to the server 4 when the user presses an “OK” button. In this case, the user may use the operation panel of the user interface to re-set the format of the estimate prepared by use of the attached format file.

(1) Estimate Issuing Process

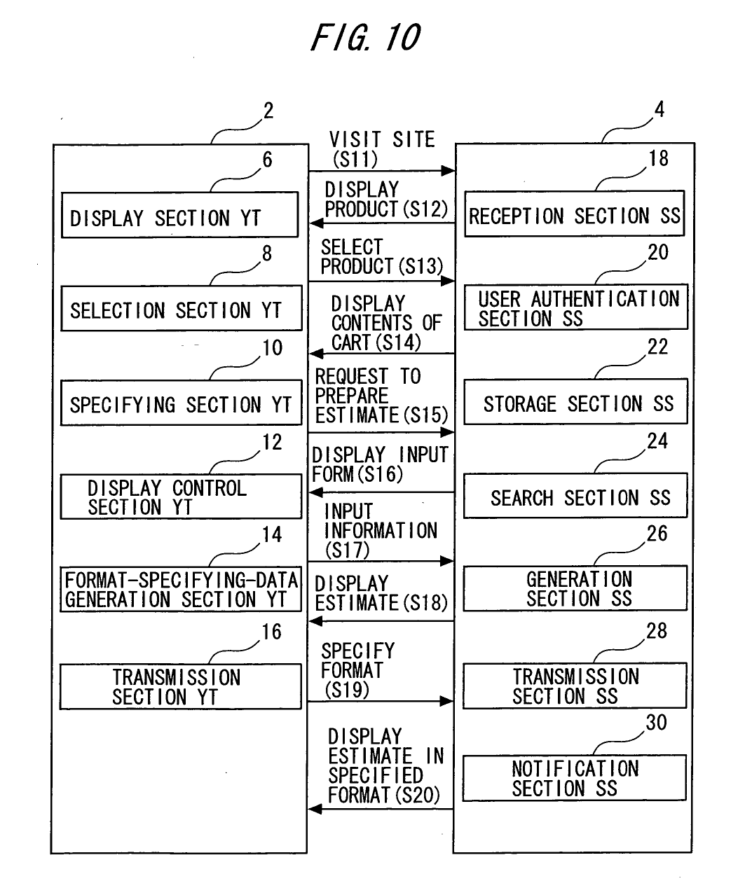

FIG. 10 is a flowchart showing a process in which an online shopping site issues an estimate in the format specified by the user. Next, a process flow between the user terminal 2 and the online shopping site (server 4) and a configuration of each device will be described. The user terminal 2 accesses the server 4 through a communication line such as the Internet.

The user terminal 2 includes: (a) a display section YT 6 for displaying information received from the server 4; (b) a selection section YT 8 for selecting a product to be purchased from the product selection screen displayed on the display section YT 6 or selecting each item on the estimate; (c) a specifying section YT 10 for specifying an attribute of a selected item; (d) a display control section YT 12 for changing the display condition of a selected item in accordance with the specified attribute; (e) a format-specifying-data generation section YT 14 for generating a format file from attribute information of each item in the estimate displayed on the display section YT 6; and (f) a transmission section YT 16 for transmitting generated format files or various requests.

The server 4 includes: (a) a reception section SS 18 for receiving from the user terminal 2, a request to transmit the product selection screen, information on a selected product, a format file, and other various kinds of information; (b) a user authentication section SS 20 for authenticating an access from the user terminal 2, by using user identification information (ID, password, or the like); (c) a storage section SS 22 for storing in a database user registration information or format files transmitted from the user terminal 2; (d) a search section SS 24 for searching the database stored in the storage section for a format file by using information identifying a user, such as user identification information (user name, ID, password, or the like), as a key; (e) a generation section SS 26 for generating an estimate based on the user registration information, information on the selected product, and the format file; (f) a transmission section SS 28 for transmitting the generated estimate to the user terminal 2; and (g) a notification section SS 30 for sending a notification by sending the generated estimate to an administrator or the like of the server 4 when a new item, other than items defined in advance, is specified in the format file.

In Step S11, the user accesses a shopping site through an operation of, for example, inputting a URL (Uniform Resource Locator) to a browser on the user terminal 2 and requests the shopping site to transmit a product selection screen (visiting the site).

In Step S12, the server 4 transmits the product selection screen (HTML file) corresponding to the URL to the user terminal 2. The product selection screen is presented to the user with plural products dealt by the site being displayed on a web page (displaying products).

In Step S13, the user selects a product to be purchased by using a mouse, a keyboard, or a touch panel of the user terminal 2. The user terminal 2 receives the selection operation of the user and transmits information identifying the selected product, as a product which the user desires to purchase, to the server 4 (selecting a product).

In Step S14, the product selection is generally carried out through an operation of putting a product into a virtual “shopping cart (hereinafter referred to as “cart”)”. As a result of the selection, the server 4 transmits to the user terminal 2 the current contents of the cart to display the contents on the web page (displaying the contents of the cart).

In Step S15, next, when the user desires an estimate of the product currently contained in the cart, the user clicks a link or a button represented by “display estimate” or the like displayed on the web page. Then, the user terminal 2 transmits an estimate preparation request to the server 4 (preparing an estimate).

In Step S16, the server 4 receives the estimate preparation request, and transmits a lacking-information input screen to the user terminal 2 in order to display information (lacking information) such as an “address” necessary for preparing the estimate, on the web page of the user terminal 2 (displaying an input form).

In Step S17, the user manipulates the keyboard or the like to input lacking information on the input screen displayed on the display section (inputting information). When the server 4 judges that there is no lacking information, the server 4 starts to prepare the estimate without transmitting the input screen to the user terminal 2.

In Step S18, judging that collection of necessary information (product information, user information, and the like) for preparing the estimate has been completed, the server 4 prepares the estimate by applying a predetermined format file to the contents (product information, user information, and the like). The server 4 then transmits the prepared estimate to the user terminal 2. The user terminal 2 displays the received estimate (displaying the estimate).

Steps S11 to S18 described above are conventional processes performed in general shopping sites. The present invention allows the next process to be performed so that the user can change or specify the format of the estimate prepared in advance by the server 4.

In Step S19, the user uses the operation panel of the user interface shown in FIG. 8 to change the order of the setting items or to set attributes. When the user presses the “OK” button, the format-specifying-data generation section YT 14 generates a format file and the transmission section YT 16 transmits the generated format file to the server 4 (specifying the format).

In another method, it is possible that a format file as shown in FIG. 4 or 6 prepared in advance by the user is attached, and when the user presses the “OK” button, the user terminal 2 transmits the attached format file to the server 4 (FIG. 9). In this case, the method may be such that the user can use the operation panel of the user interface to re-set the format of the estimate prepared using the attached format file.

Further, when the estimate is prepared using the attached format file, the format file name which has been used for preparing the estimate may be displayed on the estimate. This makes it possible for the user to know which format file has been used.

In Step S20, the server 4 prepares the estimate by applying the format file transmitted from the user terminal 2 to the data of the estimate. The server 4 transmits the prepared estimate to the user terminal 2, and the user terminal 2 displays the received estimate (displaying the estimate in the specified format).

Note that the estimate preparation process described above is an embodiment of the present invention. The user authentication may be performed at the time of visiting a shopping site to transmit user information (user registration information) necessary for preparing an estimate to the shopping site side.

In this case, the following methods are also possible: (i) a method in which displaying an input form in Step S16 and inputting information in Step S17 are omitted; (ii) a method in which specifying a format is performed at the time of inputting information in Step S17, thereby omitting displaying the estimate in Step S18 and specifying the format in Step S19; and (iii) a method in which inputting lacking information is requested after the format is specified, thereby performing displaying an input form in Step S16 and inputting information in Step S17 after Step S19.

(2) Format Application Flow

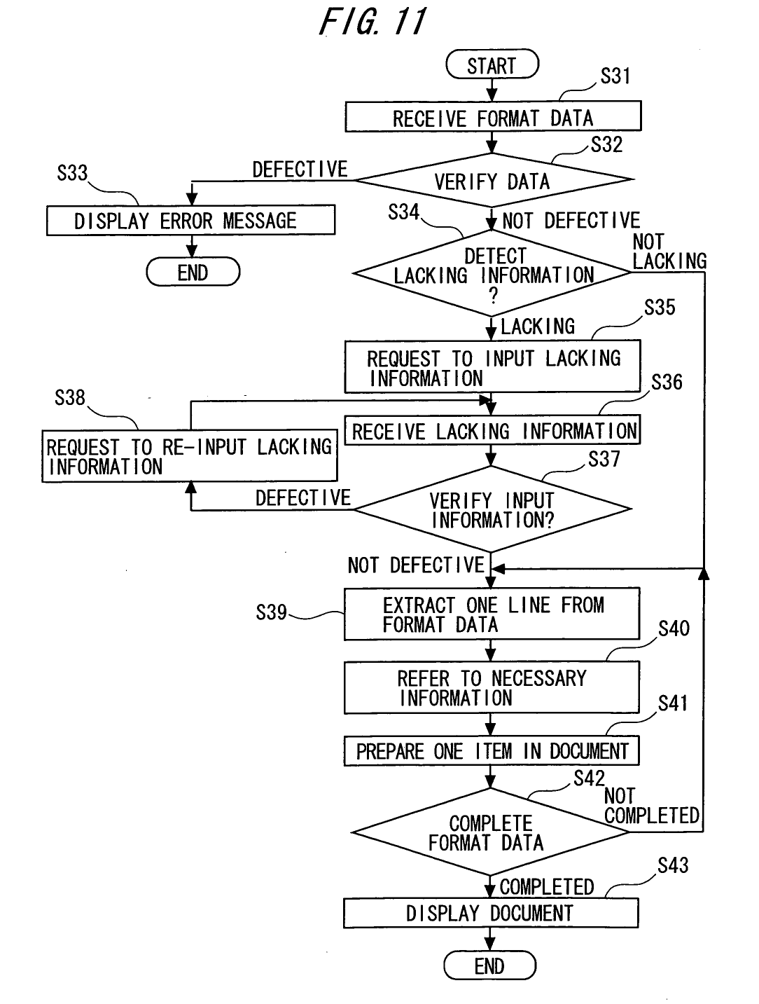

FIG. 11 is a flowchart illustrative of a process of preparing an estimate (document) performed by the server 4 using a received format file (format data). Shown in FIG. 11 are (i) a process of applying the format specified in Step S19 of FIG. 10 to estimate data and (ii) a process of preparing the estimate to be transmitted to the user terminal 2 in Step S20 of FIG. 10.

In Step S31, the server 4 receives format data transmitted from the user terminal 2 and temporarily stores the format data in a memory or the like.

In Step S32, the server 4 verifies the format data to check whether the specified format, the description contents, and the like are defective or not. As a result of the verification, if the defective description contents are found, the process of applying the format to the description contents is stopped, and a transition to Step S33 is made.

To give an example of a defective specified format, there is a case in which, with respect to a new item added by the user, the new item to be displayed on the estimate has been described in the format file as an already defined item. Taken as an example is a case in which format data is described as “A, 8, 2, 6, “12345”, “management number”, 6”. This case is defective because the format data “A” is an item already defined. In this embodiment, a new item is to be described in the format file as “J, 8, 2, 6, “12345”, “management number”, 6”. A procedure of adding a new item will be described later.

To give an example of a defective description content, there is a case in which, with respect to a new item added by the user, the new item to be displayed on the estimate is described in the format file as an already defined item. Taken as an example is a case in which format data is described as “A, 8, 2, 6, “Jun. 2, 2000”, “date of issue”, 6”. This case is defective because the format data “date of issue”0 is an item already defined.

In Step S33, the server 4 generates an error message reporting a content of a defective and transmits it to the user terminal 2. The user can modify the format file by referring to the error message transmitted from the server 4.

In Step S34, whether or not there are all pieces of data necessary for preparing the estimate is verified. If a necessary matter such as an “address” to be described on the estimate is lacked, a transition is made to Step S35 where the user is requested to input information. If there is no lacking necessary matter, a transition is made to Step S39 where preparation of the estimate is started. The necessary matters may be set as parameters in a program executed on the server 4. Alternatively, a database storing the necessary matters may be provided in the server 4 to be referred to by the program on the server 4.

In Step S35, the server 4 generates input-screen data for requesting to input lacking information and transmits it to the user terminal 2. The user terminal 2 displays an input form or the like based on the input-screen data.

In Step S36, the server 4 receives lacking information (additional information) input in the user terminal 2.

In Step S37, the server 4 verifies the input additional information. Here, if the additional information received from the user terminal 2 is defective, a transition is made to Step S38 where the user terminal 2 is again requested to input lacking information. If the additional information is not defective, a transition to Step S39 is made.

In Step S39, the server 4 extracts data for each process unit from the format data.

In Step S40, in order to apply information (specified format data) indicated by the process unit extracted in Step S39 to the estimate data, items such as product information (the product name, the model number, the quantity, the unit price, or the like) held by the server 4 are referred to and thus described in the estimate.

In Step S41, the server 4 arranges and processes information of the items referred to in Step S40, according to the specified format data indicated in each process unit extracted in Step S39. The server 4 then forms a part of the final estimate.

In Step S42, the server 4 checks the format data if there is an unextracted process unit left. If an unextracted process unit is left, a transition to Step S39 is made to extract the next process unit. If an unextracted process unit is not left, a transition to Step S43 is made.

In Step S43, the server 4 collects parts (data corresponding to each process unit) generated in Step S41 and prepares the final estimate. Then, the completed estimate is transmitted to the user. Through the above-described steps, the process of applying the specified format to the estimate data is completed.

(3) Method of Managing User Registration Information

Some shopping sites are equipped with a mechanism of “user registration” which simplifies a purchase procedure for the second and subsequent purchases by registering user information in the site at the time of the first purchase. In the present invention, the mechanism of “user registration” may be applied to make it possible to reuse “format data” once specified by the user.

The user registration information and the format data can be associated with each other by, for example, recording the format data on a file independently provided for each user and recording its file name as one item of user registration information.

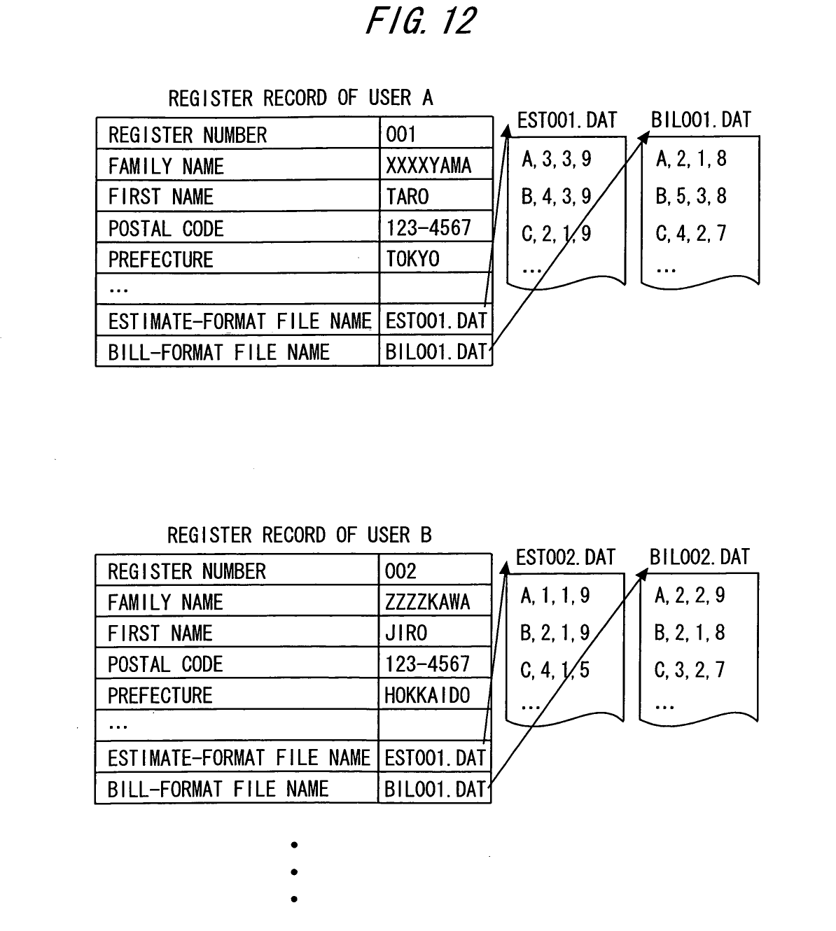

FIG. 12 is a diagram showing an example of association of the user registration information registered in the server 4 and format data. FIG. 12 shows an example of creating a registration record in a database in which names, addresses, and the like are registered as user information. The database is made in the storage section in the server 4 or outside the server 4.

The database stores format files generated for each user for each type of document. In FIG. 12, “Est001.dat” is an estimate format file for a user A, “Bil001.dat” is a bill format file for the user A, “Est002.dat” is an estimate format file for a user B, and “Bil002.dat” is a bill format file for the user B.

When the user A visits a site, selects a product, and requests to issue an “estimate”, a result of user authentication is used to draw “Est001.dat” associated with an “estimate-format file name” from the registration record of the user A, and the format file “Est001.dat” is read to obtain format data for preparing an estimate.

In a process of preparing a document, the server 4 refers to the format file name from the user registration information. If the format file name has been registered, the server 4 reads the format file associated with the format file name. If the format file name has not been registered, the server 4 requests the user terminal 2 to transmit a specified format.

In order to store the format file transmitted from the user terminal 2, in association with its format file name, the server 4 registers a file name of the format file in the user registration information. Even when the format file has already been registered, if a new format file is presented from the user terminal 2, the server 4 performs overwriting, addition, modification, or the like of the format file.

(4) Procedure of Adding a New Item Not Existing in a Standard Template

Some users desire to add a new item because a document template prepared in advance by a site side is insufficient in terms of its items. For example, it may be considered that the user desires to display a unique “management number” for managing an estimate in the estimate.

Such a case is handled by providing a mechanism capable of specifying a “new item” in format data presented by the user to the site.

For example, in the method of “uploading a format file” described in this embodiment, it is sufficient if one or more items can be added at or after [J] in addition to the items [A] to [I] prepared by the site. However, the following points are taken into consideration to add a new item.

(1) Since the site does not manage “a value (data)” of the new item, the user inputs data for preparing the document. In this case, preferably, the value itself is also contained in the format file. In this embodiment, following the normally-prepared attributes (a) to (c) of for each item, a “value” of an attribute is described as (d).

(2) Next, since an “item name” such as “date of issue” is not set for the new item, it is necessary to perform a designation about display of the item name. In this embodiment, this can be achieved by specifying an item name for screen display as (e), and a character size of the item name as (f).

The new item relating to the above-described two points can be shown in the following way, expressed in the same CSV format as in this embodiment. With this designation, data having a value of “12345” is added under an item name of “management number” at a font size of 6, right adjusted, on the eighth line in the estimate. “J, 8, 2, 6, “12345”, “management number”, 6”

(3) Finally, there is an issue of the “reliability” of documents, caused when the user can freely add a new item. When a program on the server 4 automatically prepares a document and transmits document data to the user terminal 2, a site administrator cannot grasp an item additionally input by the user. Therefore, a document having a content which the document issuer does not intend to describe may be prepared.

There is a need to prevent documents having a content which the document issuer does not intend to describe from being issued. For example, when a format file specifying the addition of a new item is transmitted from the user terminal 2, a message to the effect that “The specified format is now being approved. Please wait for a while until the approval” is transmitted to the user terminal 2. After human auditing by the site administrator, the specified format may be made available.

In addition, in order for the user to confirm an unapproved estimate, document data may be generated and transmitted to the user terminal 2. In this case, the estimate needs to indicate that this is not a formal document with an official seal of the company and that the estimate is now being approved.

After the human auditing by the site administrator, the format file including the new item may be registered in the server 4, and the server 4 may generate a screen for displaying plural format files in a selection-allowed manner on the user terminal 2 such that the server 4 can automatically issue a document through the normal operations described above.

With the communication apparatus, the document receiver side can easily obtain a desired document. Further, on the document provider side, a process of preparing in advance plural types of formats to meet various demands and a process of individually dealing with each user become unnecessary. Therefore, operation efficiency is improved.

Furthermore, the user can obtain a document in a desired format by specifying, when preparing a document, not only a layout but additional information, if necessary at the receiver side. Even when the receiver side specifies a new item, the new item is sequentially added to the template so that a duplicated request from the receiver side can be prevented.

If the receiver side merely desires to obtain a document in a desired format, a method can be used in which the provider side provides only “data” in a form of CSV or XML, and the receiver side processes the data into a desired data display format.

However, with this method, a final “document creator” is the “receiver side”, so there arises a serious question for the “reliability” of the document. That is because the receiver may set an item advantageous to the receiver. On the other hand, with the technique according to the communication apparatus, the final document creator is the “provider side”, and the receiver cannot modify items other than a new item. Therefore, the reliability of a document is ensured by the system of the provider side. If necessary, an electronic signature for preventing tampering can be added to further improve the reliability.

According to the present invention, the provider side can automatically issue a document by using a format of a document specified by the receiver side.

1. A communication apparatus, comprising:
a reception section that receives format-specifying data specifying an attribute relating to a format of a document and data which identifies contents to which the format is applied, from a communication terminal;
a generation section that generates document data by applying the format-specifying data to the identified contents; and
a transmission section that transmits the document data generated by the generation section.

2. The communication apparatus according to claim 1, further comprising a storage section that stores user registration information for identifying a user, transmitted from the communication terminal, wherein the storage section stores the format-specifying data in association with the user registration information.

3. The communication apparatus according to claim 2, further comprising an authentication section that authenticates user identification information for identifying a user, transmitted from the communication terminal, wherein, when user registration information corresponding to the user identification information is stored in the storage section, the generation section generates the document data by using format-specifying data associated with the user registration information.

4. The communication apparatus according to claim 1, wherein the generation section generates the document data to which additional information whose attribute cannot be specified by using the format-specifying data is added.

5. The communication apparatus according to claim 1, further comprising:
a verification section that verifies whether the format-specifying data received by the reception section includes data relating to a new item; and
a notification section that sends a notification, when data relating to a new item is included, to an administrator of the communication apparatus by transmitting the document data.

6. The communication apparatus according to claim 1, wherein the format-specifying data includes, for each item to be displayed on the document data, display s or a display/non-display state set when information corresponding to the item is displayed; and
the generation section generates each item on the document data in accordance with the display s or the display/non-display state.

7. A communication apparatus, comprising:
a display section that selectively displays each of a plurality of items in a document in a selection-allowed manner;
a selection section that selects the item displayed on the display section;
a specifying section that specifies an attribute with respect to the selected item;
a display control section that changes a display attribute of the selected item in accordance with the specified attribute; and
a format-specifying-data generation section that generates format-specifying data which includes data indicating attributes with respect to the plurality of items displayed on the display section.

8. The communication apparatus according to claim 7, wherein the display control section switches a display/non-display state of the selected item.

9. The communication apparatus according to claim 7, wherein the display control section changes an arrangement or a font attribute of the selected item.

10. The communication apparatus according to claim 7, further comprising a transmission section that transmits the format-specifying data generated by the format-specifying-data generation section, through a communication line.

11. The communication apparatus according to claim 7, wherein the format-specifying data includes, for each item to be displayed on document data, display s or a display/non-display state set when information corresponding to the item is displayed; and
the generation section generates each item on document data in accordance with the display s or the display/non-display state.

12. A communication method, comprising:
a reception step of receiving format-specifying data specifying an attribute relating to a format of a document and data which identifies contents to which the format is applied, from a communication terminal;
a generation step of generating document data by applying the format-specifying data to the identified contents; and
a transmission step of transmitting the document data generated in the generation step.

13. The communication method according to claim 12, further comprising a storage step of storing user registration information for identifying a user, received from the communication terminal, wherein the storage step comprises storing the format-specifying data in association with the user registration information.

14. The communication method according to claim 13, further comprising an authentication step of authenticating user identification information for identifying a user, transmitted from the communication terminal, wherein, when user registration information corresponding to the user identification information is stored in the storage step, the generation step comprises generating document data by using format-specifying data associated with the user registration information.

15. The communication method according to claim 12, wherein the generation step comprises generating the document data to which additional information whose attribute cannot be specified by using the format-specifying data is added.

16. The communication method according to claim 12, further comprising:
a verification step of verifying whether the format-specifying data received in the reception step includes data relating to a new item; and
a notification step of sending a notification, when data relating to a new item is included, to an administrator of the communication method by transmitting the document data.

17. The communication method according to claim 12, wherein the format-specifying data includes, for each item to be displayed on the document data, display s or a display/non-display state set when information corresponding to the item is displayed; and
the generation step comprises generating each item on the document data in accordance with the display s or the display/non-display state.

18. A data generating method, comprising:
a display step of displaying each of a plurality of items in a document in a selection-allowed manner;
a selection step of selecting the item displayed in the display step;
a specifying step of specifying an attribute with respect to the selected item;
a display-control step of changing a display attribute of the selected item in accordance with the specified attribute; and
a format-specifying-data generation step of generating format-specifying data which includes data indicating attributes with respect to the plurality of items displayed in the display step.

19. The data generating method according to claim 18, wherein the display-control step comprises switching a display/non-display state of the selected item.

20. The data generating method according to claim 18, wherein the display-control step comprises changing an arrangement or a font attribute of the selected item.

21. The data generating method according to claim 18, further comprising a transmission step of transmitting the format-specifying data generated in the format-specifying-data generation step, through a communication line.

22. A communication program causing a computer to execute:
a reception step of receiving format-specifying data specifying an attribute relating to a format of a document and data which identifies contents to which the format is applied, from a communication terminal;
a generation step of generating document data by applying the format-specifying data to the identified contents; and
a transmission step of transmitting the document data generated in the generation step.

23. The communication program according to claim 22, wherein the program further causes the computer to execute a storage step of storing user registration information for identifying a user, received from the communication program, wherein the storage step comprises storing the format-specifying data in association with the user registration information.

24. The communication program according to claim 23, wherein the program further causes the computer to execute an authentication step of authenticating user identification information for identifying a user, transmitted from the communication program, wherein, when user registration information corresponding to the user identification information is stored in the storage step, the generation step comprises generating document data by using format-specifying data associated with the user registration information.

25. The communication program according to claim 22, wherein the generation step comprises generating the document data to which additional information whose attribute cannot be specified by using the format-specifying data is added.

26. The communication program according to claim 22, wherein the program further causes the computer to execute:
a verification step of verifying whether the format-specifying data received in the reception step includes data relating to a new item; and
a notification step of sending a notification, when data relating to a new item is included, to an administrator of the communication program by transmitting the document data.

27. The communication program according to claim 22, wherein the format-specifying data includes, for each item to be displayed on the document data, display s or a display/non-display state set when information corresponding to the item is displayed; and
the generation step comprises generating each item on the document data in accordance with the display s or the display/non-display state.

28. A data generating program, comprising:
a display step of displaying each of a plurality of items in a document in a selection-allowed manner;
a selection step of selecting the item displayed in the display step;
a specifying step of specifying an attribute with respect to the selected item;
a display-control step of changing a display attribute of the selected item in accordance with the specified attribute; and
a format-specifying-data generation step of generating format-specifying data which includes data indicating attributes with respect to the plurality of items displayed in the display step.

29. The data generating program according to claim 28, wherein the display-control step comprises switching a display/non-display state of the selected item.

30. The data generating program according to claim 28, wherein the display-control step comprises changing an arrangement or a font attribute of the selected item.

31. The data generating program according to claim 28, further comprising a transmission step of transmitting the format-specifying data generated in the format-specifying-data generation step, through a communication line.
